(19) United States
(12) Patent Application Publication
(10) Pub. No.: US 2013/0334956 A1
(43) Pub. Date: Dec. 19, 2013

(54) REMOTE PHOSPHOR TAPE LIGHTING UNITS

(71) Applicant: Eric Bretschneider, Bowling Green, KY (US)

(72) Inventor: Eric Bretschneider, Bowling Green, KY (US)

(73) Assignee: NEXT LIGHTING CORO.

(21) Appl. No.: 13/696,057

(22) PCT Filed: May 5, 2011
(86) PCT No.: PCT/US2011/035376

§ 371 Date: Aug. 30, 2013

Related U.S. Application Data
(60) Provisional application No. 61/331,638, filed on May 5, 2010.

(51) Int. Cl. F21K 99/00

(52) U.S. Cl. CPC F21K 9/56
USPC 313/498; 428/195.1; 428/457; 428/343; 252/1

(57) ABSTRACT

The invention provides systems and methods relating to remote phosphor tapes and methods of making and using the same. A remote phosphor tape may be used in lighting units. The phosphor tape may comprise a front side and a backside. The phosphor tape may have a phosphor layer comprising a phosphor material configured to emit light of an emission wavelength when illuminated by light of an excitation wavelength. The remote phosphor tape is configured for use as a remote phosphor in a lighting unit.

### CROSS-REFERENCE

This application claims the benefit of U.S. Provisional Application No. 61/331,638, filed May 5, 2010, which application is incorporated herein by reference in its entirety.

### TECHNICAL FIELD

Aspects of the invention relate to techniques and materials that can be used to process radiant energy from light emitting elements such as light emitting diodes using remote phosphors in a tape form, typically so as to produce substantially white light of desired characteristics.

### BACKGROUND OF THE INVENTION

Solid state light emitters, such as light emitting diodes (LEDs), are being developed for use in general illumination applications due to their long lifetimes and high efficiencies. However, the efficiency and lifetimes are reduced by typical methods used to create a desirable white light for illumination.

There are two main approaches to making white light using LEDs. One approach uses direct emission from multiple monochromatic LEDs. Typically, this approach requires electro-optical devices to control the blending the light emitted by red, green, and blue (RGB) LEDs. A second, more developed approach uses phosphor converted LEDs (pcLEDs) to create white light. In this approach, white LEDs are typically created using blue emitting chips coated with a yellow phosphor, or a near-UV emitting chip coated with a tri-phosphor blend of red, green and blue emitting phosphors. The phosphor absorbs the blue- or near-UV light from the LED and re-emits it at a different, longer wavelength such that white light can be obtained. However, about half of the photons produced by the phosphor are diverted back toward the LED chip where much of the light is lost due to absorption, and the phosphor lifetime and efficiency is compromised by the proximity of the phosphor material to the heat-generating LED device, which leads to thermal degradation of the phosphor. Thermal degradation of the phosphor in turn can lead to a lack of color consistency of the LED device over time. Furthermore, phosphor deposition must be precisely controlled to produce LED devices having a consistent white color. Phosphor deposition processes for remote phosphor applications may be difficult to obtain in certain device configurations, or deposition processes may be inefficient, causing a loss of expensive phosphor material.

Hence, a need exists for more effective techniques and materials to facilitate the use of phosphors as wavelength converting materials in lighting devices to produce white light of desirable quality. Features of high quality white light for illumination can include high color rendering index (CRI), a desired correlated color temperature (CCT), color consistency with time, and color consistency between devices.

### SUMMARY OF THE INVENTION

Aspects of the invention relate to remote phosphor tape for use in lighting units. The remote phosphor tape may comprise a front side, a back side, and a phosphor layer comprising a phosphor material configured to emit light of an emission wavelength when illuminated by light of an excitation wavelength. The phosphor tape is configured for use as a remote phosphor in a lighting unit. The phosphor layer may comprise a combination of one or more phosphor materials in a binder material or disposed on a substrate layer.

The invention also relates to lighting units comprising such a remote phosphor tape. The lighting unit may comprise at least one light emitting element, configured to emit a light of at least one excitation wavelength when illuminated, a support structure spatially separated from the light emitting element, and a remote phosphor tape disposed on the support structure. The light emitting element and the remote phosphor tape are positioned such that a portion of the light emitted by the light emitting element is received by the phosphor layer in the remote phosphor tape.

An aspect of the invention is directed to a remote phosphor tape for use in lighting units. The remote phosphor tape may comprise a front side; a backside; and a phosphor layer comprising a phosphor material configured to emit light of an emission wavelength when illuminated by light of an excitation wavelength, wherein said remote phosphor tape is configured for use as a remote phosphor in a lighting unit.

A lighting unit may be provided in accordance with another aspect of the invention. The lighting unit may comprise at least one light emitting element, configured to emit a light of at least one excitation wavelength when illuminated; a support structure spatially separated from the at least one light emitting element; and a remote phosphor tape disposed on said support structure, the remote phosphor tape comprising a front side; a back side; and a phosphor layer comprising a phosphor material configured to emit light of a emission wavelength when illuminated by the light of at least one excitation wavelength, wherein the at least one light emitting element and the remote phosphor tape are positioned such that a portion of the light of at least one excitation wavelength emitted by the at least one light emitting element is received by the phosphor layer in the remote phosphor tape.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a schematic cross-sectional view of a remote phosphor tape, wherein the phosphor is embedded in a polymeric binder material.

FIG. 1B is an alternative cross-sectional view of a remote phosphor tape.

FIG. 2A is a schematic cross-sectional view of a remote phosphor tape wherein a phosphor layer is disposed on a reflective tape.

FIG. 2B is an alternative cross-sectional view of a remote phosphor tape wherein a phosphor layer is disposed on a reflective tape.

FIG. 2C is an additional cross-sectional view of a remote phosphor tape mounted on a substrate.

FIG. 3 is a perspective view of a roll of remote phosphor tape.

FIG. 4 is a schematic cross-sectional view of a piece of remote phosphor tape being applied to an example support structure in an illustrative lighting unit.

FIG. 5 is a schematic cross-sectional view of an illustrative lighting unit comprising a reflective remote phosphor tape.

FIG. 6a is a perspective view of another lighting unit comprising a remote phosphor tape.

FIG. 6b is a schematic cross-sectional view of the lighting unit of FIG. 6a comprising a remote phosphor tape.

FIG. 7 is a schematic cross-sectional view of another lighting unit comprising a substantially transparent remote phosphor tape disposed on a narrow support structure.

### DETAILED DESCRIPTION OF ILLUSTRATIVE EMBODIMENTS

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Aspects of the invention relate to remote phosphor tapes and methods of making and using the same. All references cited in this application are hereby incorporate by reference in their entirety. In particular, the disclosure of the following: U.S. Provisional Application, “Lighting unit having lighting strips with light emitting elements and a remote phosphor material” filed Feb. 17, 2010 having Ser. No. 61/338,268; U.S. patent application, “Lighting Unit Having Lighting Strips with Light Emitting Elements and Remote Luminescent Material” filed Feb. 16, 2011 having Ser. No. 13/029,000, are hereby incorporated by reference in their entirety.

The invention provides systems and methods for remote phosphor tapes which may be used in providing illumination. Various aspects of the invention described herein may be applied to any of the particular applications set forth below or for any other types of lighting units or lighting strips. The invention may be applied as a standalone system or method, or as part of an integrated illumination system. It shall be understood that different aspects of the invention can be appreciated individually, collectively, or in combination with each other.

### TERMINOLOGY

The term “color” as used herein can mean a wavelength or any combination of monochromatic light in the visible range of electromagnetic radiation, such as red, orange, yellow, green, blue, violet, or white, or a wavelength in the near infrared range, or the ultraviolent (UV) range of light. Electro-luminscence (EL) devices can emit light of a plurality of wavelengths and their emission peaks can be very broad or narrow.

The term “plurality” has the meaning of “one or more”.

The term “adjacent to” as used herein denotes a relative positioning of two articles that are near one another. Adjacent items can be touching, or separated by one or more layers.

### Remote Phosphor Tape

Aspects of the invention relate to tape comprising phosphor material which is configured to be used as a remote phosphor in lighting units to color-convert light from at least one light emitting element to light with desirable color characteristics. The term phosphor as referred to herein refers to any phosphor material or combination of materials that phosphoresces or fluoresces when excited by light from the light emitting elements. The term phosphor and phosphor material are used interchangeably herein. The phosphor material can be an inorganic material, an organic material, or a combination of inorganic and organic materials. The phosphor material can be a quantum-dot based material or nanocrystal. Numerous phosphor material formulations can be used dependent on the excitation spectra provided by the light emitting elements and the output light characteristics desired. For example, when the light emitting elements provide an emission spectrum yielding white light with a high correlated color temperature, phosphors emitting light of a red and/or orange wavelength can be used to achieve lower/warmer correlated color temperature white light and to improve the color rendering index. Developments in luminescent materials and applications are generally described in Adrian Kitai, Luminescent Materials and Applications, Wiley (May 27, 2008) and Shigeo Shionoya, William Yen, and Hajime Yamamoto, Phosphor Handbook, CRC Press 2nd edition (Dec. 1, 2006), which are hereby incorporated by reference in their entirety.

A remote phosphor refers to a phosphor material that is not inside or in physical contact with the light emitting element that is used to excite the phosphor material. For lighting units comprising one or more light emitting diodes (LEDs), a remote phosphor is spatially separated from the LED package. One advantage of using a remote phosphor is that color consistency of a lighting unit product can be enhanced through control of the formulation and deposition of the phosphor material. For instance, when LEDs are fabricated they are binned according to their color characteristics. LEDs from different bins can be used in production of lighting units without sacrificing product to product color consistency if the quantity and formulation of the phosphor material is adjusted depending upon the exact spectral power density provided by LEDs.

Another advantage of using a remote phosphor material is that there is reduced thermal quenching of the phosphor material because it is physically displaced from the heat generating LED package. Thus, the color of the light is more consistent with lifetime and operating temperature. In comparison, in a luminaire that employs a typical warm white LED, the red and/or orange phosphor material is in direct contact with the LED package and will quench rapidly as the LED is operated at higher temperature resulting in a noticeable shift in color point.

A further advantage of using a remote phosphor material is that to achieve a warmer color temperature, the selection of the phosphor material is not limited only to materials that can operate well at higher temperatures. This can open up a range of materials that are not available to typical LED configurations. Still another advantage of using a remote phosphor material is an increased phosphor material lifetime due to the decreased operating temperature.

### Phosphor in Binder

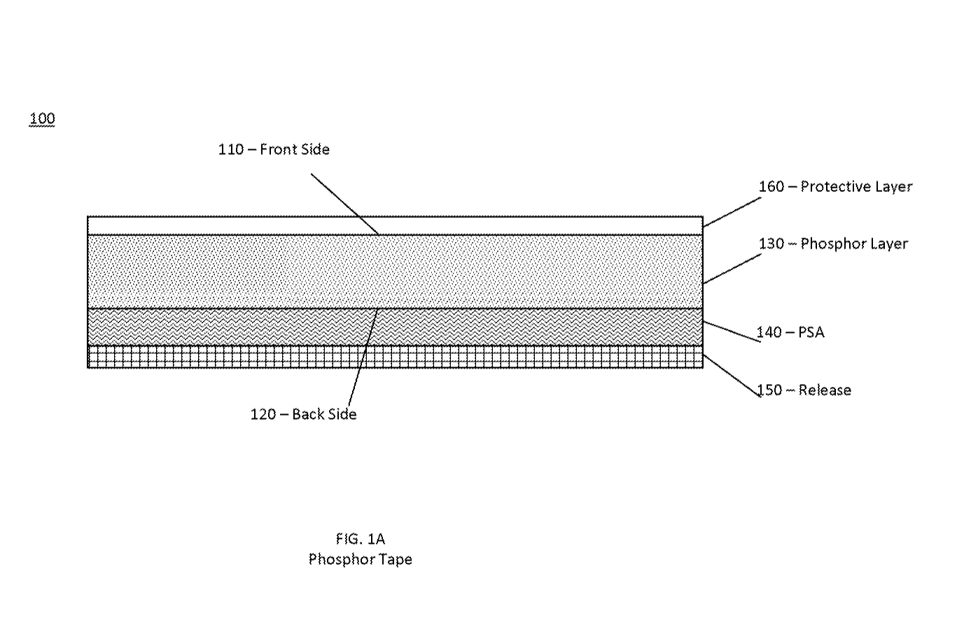

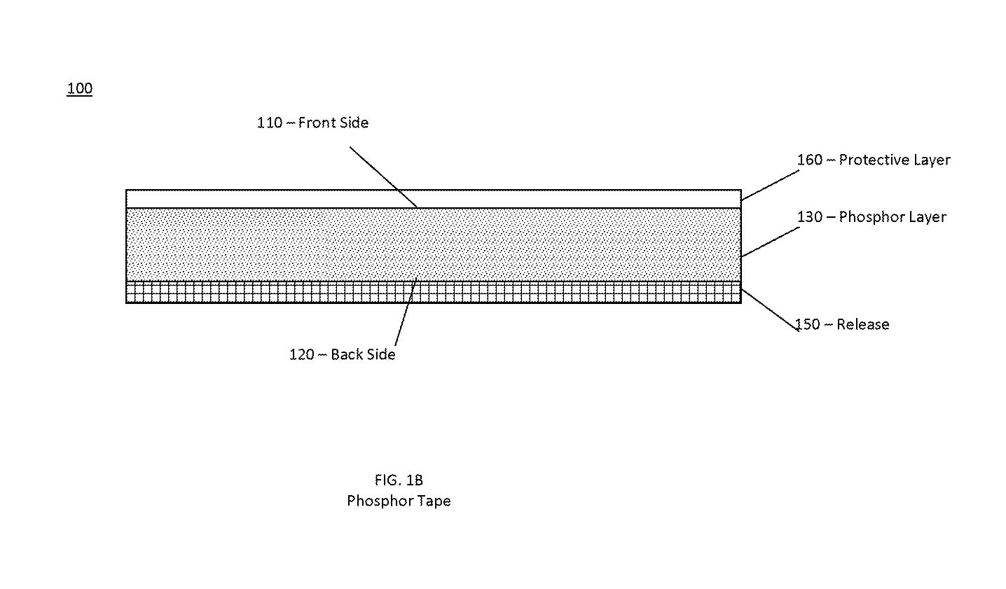

In one embodiment of the invention, the remote phosphor tape comprises a phosphor layer which is formed using a combination of one or more phosphor materials mixed in a binder material. FIG. 1A is a schematic cross-sectional view of an example of such a remote phosphor tape 100 having a front side 110 and a back side 120. The remote phosphor tape 100 includes a phosphor layer 130 comprising a combination of one or more phosphor materials and a substantially transparent polymeric binder material. A pressure sensitive adhesive (PSA) layer 140 and a release liner 150 may optionally be disposed adjacent the back side 120 of the remote phosphor tape 100. A protective layer 160 may be disposed on the front side 110 of the remote phosphor tape to protect the phosphor layer 130. Any of the phosphor layer 130, pressure sensitive adhesive layer 140, release liner 150, or protective layer 160 need not be continuous layers.

FIG. 1B provides an alternative cross-sectional view of a remote phosphor tape. A remote phosphor tape 100 may have a front side 110 and a back side 120. The remote phosphor tape may have a phosphor layer 130 comprising a combination of one or more phosphor materials and a substantially transparent polymeric binder material. A release liner 150 may optionally be provided adjacent to the back side 120 of the phosphor tape. The release liner may directly contact the phosphor layer. A protective layer 160 may be disposed on the front side 110 of the remote phosphor tape to protect the phosphor layer 130. Any of the phosphor layer 130, release liner 150, or protective layer 160 need not be continuous layers.

### Remote Phosphor Tape Comprising Substrate Layer

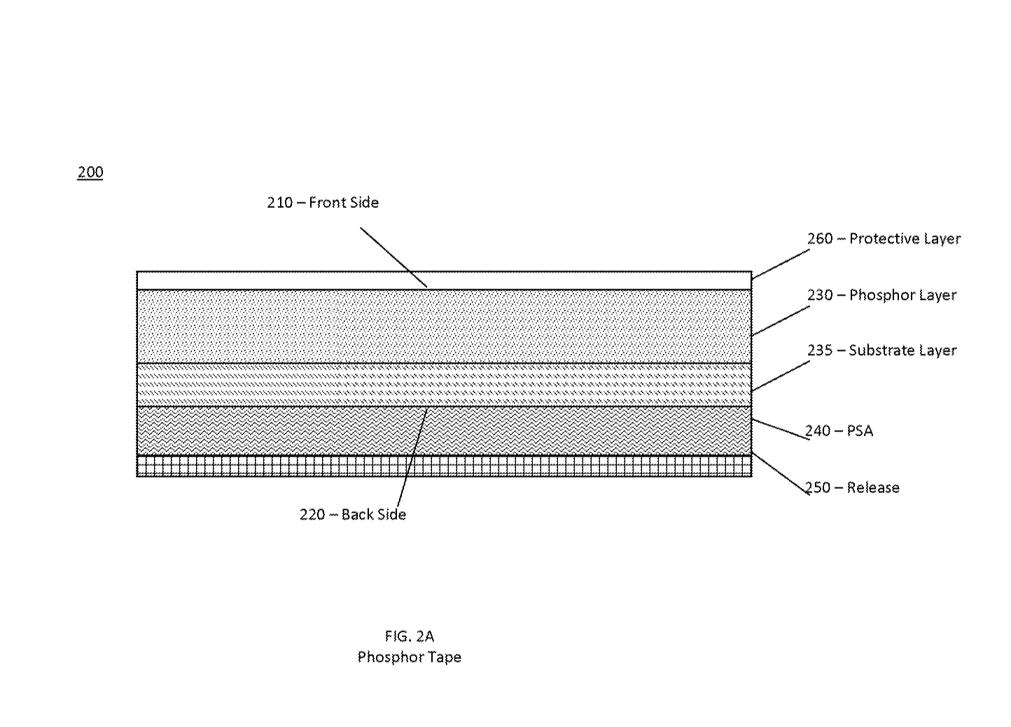

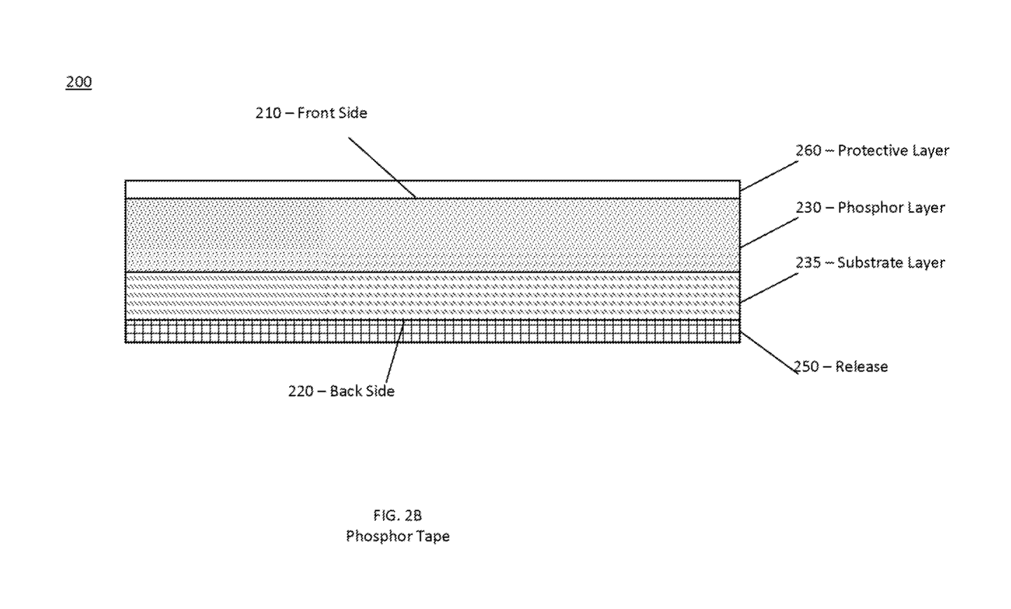

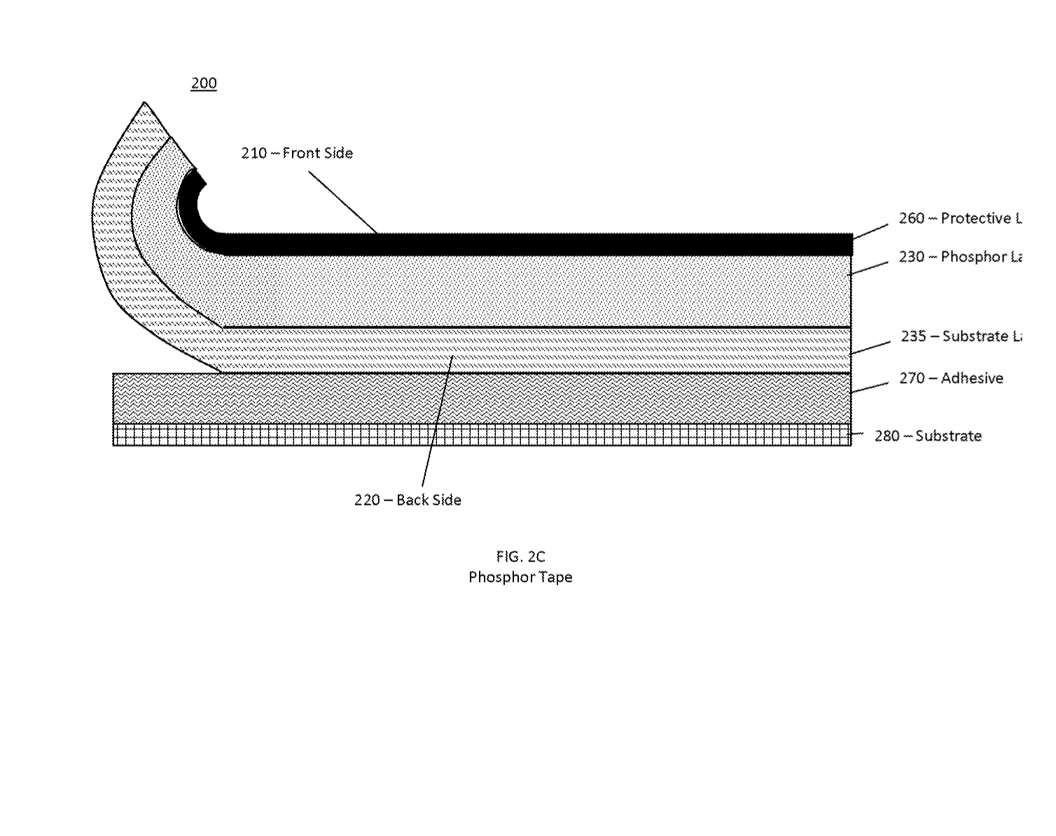

FIG. 2A is a schematic cross-sectional view of an example of a substantially transparent remote phosphor tape 200 having a front side 210 and a back side 220. The remote phosphor tape 200 includes a phosphor layer 230 comprising a combination of one or more phosphor materials disposed on a substrate layer 235. The phosphor layer may further comprise a binder material. A pressure sensitive adhesive layer 240 and a release liner 250 may optionally be disposed adjacent the back side 220 of the remote phosphor tape 200, such that the substrate layer is sandwiched between the phosphor layer and the pressure sensitive adhesive layer. A protective layer 260 may be disposed on the front side 210 of the remote phosphor tape to protect the phosphor layer 230. Additional layers may also be included in the phosphor tape. At least one of the substrate layer 235 or the protective layer 260 is substantially transparent to visible light, such that excitation light may reach the phosphor layer and light generated by the phosphor layer may exit the remote phosphor tape. Any of the phosphor layer 230, substrate layer 235, pressure sensitive adhesive layer 240, release liner 250, or protective layer 260 need not be continuous layers. In particular, the phosphor layer need not be continuous. Some regions of the substrate layer may be coated with phosphor material while other regions are not coated. For example, the phosphor layer may be printed onto the substrate layer and the phosphor materials may form a pattern on the tape.

FIG. 2B provides a cross-sectional view of an example of a substantially transparent remote phosphor tape 200 having a front side 210 and a back side 220. The remote phosphor tape 200 may include a phosphor layer 230 comprising a combination of one or more phosphor materials disposed on a substrate layer 235. The phosphor layer may further comprise a binder material. A release liner 250 may optionally be disposed adjacent the back side 220 of the remote phosphor tape 200, such that the substrate layer may directly contact the release liner. A protective layer 260 may be disposed on the front side 210 of the remote phosphor tape to protect the phosphor layer 230. Additional layers may also be included in the phosphor tape. At least one of the substrate layer 235 or the protective layer 260 may be substantially transparent to visible light, such that excitation light may reach the phosphor layer and light generated by the phosphor layer may exit the remote phosphor tape. Any of the phosphor layer 230, substrate layer 235, release liner 250, or protective layer 260 need not be continuous layers. In particular, the phosphor layer need not be continuous. Some regions of the substrate layer may be coated with phosphor material while other regions are not coated. For example, the phosphor layer may be printed onto the substrate layer and the phosphor materials may form a pattern on the tape.

FIG. 2C is an additional cross-sectional view of a remote phosphor tape 200 mounted on a substrate 280. In some embodiments, an adhesive 270, such as a pressure sensitive adhesive may be provided on the substrate 280. The pressure sensitive adhesive 270 may be adjacent to a back side 220 of the phosphor tape 200. The pressure sensitive adhesive 270 may be adjacent to a substrate layer 235 of the tape. In alternate embodiments where a substrate layer is not included, the pressure sensitive adhesive 270 may be adjacent to a phosphor layer 230 of the tape. Alternatively, the pressure sensitive adhesive may be adjacent to an optional release layer 250 of the phosphor tape.

The substrate 280 may be coated continuously or selectively with the adhesive 270. In some embodiments, it may be desirable to have the adhesive in selected areas rather than covering the entire back of the phosphor tape 200. Some regions of the substrate may be coated with adhesive while other regions are not coated. Some regions of the substrate to be covered by the phosphor tape may be coated with adhesive while other regions are not coated. Alternatively, the entire surface of the substrate or the surface of the substrate to be covered with the phosphor tape may be coated with the adhesive. For example, adhesive 270 may be printed on the substrate 280 and the tape may be provided on the adhesive.

Adhesive may be provided directly on the remote phosphor tape 200, on the substrate 280 upon which the tape is mounted, or both. Any description of adhesive mounting on one surface may also apply to another. The adhesive may or may not be continuous. In some embodiments, the adhesive may be provided discontinuously and may provide fixed mounting points. Fixed mounting points may allow flexation between the points. In some instances flexation may be desirable to accommodate various substrate morphologies or heat effects.

In some embodiments, the remote phosphor tape comprises a substrate layer that is reflective. The substrate layer may be diffusely or specularly reflective, for example. The addition of a reflector in the phosphor tape allows for enhancements in efficiency. The excitation light that is not absorbed by the phosphor layer and would otherwise be wasted, is reflected back into the phosphor layer, increasing the effective path length of the excitation light through the phosphor, such that the light absorption by the phosphor is increased for a given thickness. Thus, the phosphor layer thickness can be reduced, because the reflector increases the efficiency of light generation in the phosphor layer.

An additional loss in phosphor converted LED (pcLED) efficiency occurs due to the directionally uncontrolled light generation in the phosphor layer. A pcLED may be an LED that has a fluorescent/phosphorescent material to convert a portion of the light emitted by an LED chip to one or more other wavelengths. In some embodiments, a pcLED may be a white LED. The phosphor material absorbs light from the LED and re-emits it at a different, longer wavelength such that white light can be obtained. However, about half the photons produced by the phosphor are diverted back toward the LED chip where much of the light is lost due to absorption. By disposing the phosphor layer onto a reflective substrate layer, the light generated by the phosphor can be directed from this base reflector towards and optical element configured to distribute the light.

The remote phosphor tape is configured to be used as a remote phosphor in a lighting unit. Thus, the loading of the phosphor in the remote phosphor tape can be greater than in a device in which the remote phosphor tape is to be applied directly to the LED package, and the index of refraction of the binder material as well as the width and thickness of the remote phosphor tape may be different than such a tape used for LED encapsulation.

### Methods of Making

The remote phosphor tape can be fabricated by disposing a combination of one or more phosphor materials onto a substrate layer in various ways, including evaporation, spray deposition, sputtering, titration, baking, painting, printing, drawing, dip coating, or other methods known in the art, for example. In some embodiments, the substrate layer may comprise grooves, pockets, or knobs into or onto which the phosphor material is disposed to control the optical distribution of the light emitted by the phosphor material.

The remote phosphor tape can also be formed by mixing a phosphor material with a binder material and either disposing this mixture onto a substrate layer or drawing the mixture into a tape form. The binder material may be a silicone, for example.

In cases where the phosphor is deposited onto a substrate layer, the phosphor layer can be uniquely tailored. In one embodiment, an inkjet printer is used to deposit phosphor onto the substrate layer. The inkjet printer may have a combination of one or more phosphor inks that can be deposited at precise locations on the tape. The inkjet printer can be used to deposit ink in the form of dots, dashes, or lines of various widths. In some embodiments, as phosphor may be printed, it may also be possible to print adhesive in selected areas. For example, an inkjet printer can deposit adhesive at precise locations on a tape or substrate. The inkjet printer can deposit the adhesive in the form of dots, dashes, or lines of variable widths.

This can be used to make remote phosphor tape that can correct device to device color inconsistency. For example, in a group of white lighting units, the product to product color characteristics may vary depending upon the color characteristics of the white LEDs supplied to create the product. A remote phosphor tape can be used to create “warmer” white light that matches the color characteristics (CRI and CCT) of other products manufactured. Thus, a lighting device manufacturer is not restricted to a certain supplier or bin from which to purchase the LEDs that go into their lighting unit. Less expensive, surplus bins can be used with the specially tailored remote phosphor taper providing color correction.

The thickness of the phosphor layer can be tailored dependent on the phosphor concentration such that absorption of excitation light and emission of phosphor-converted light are maximized.

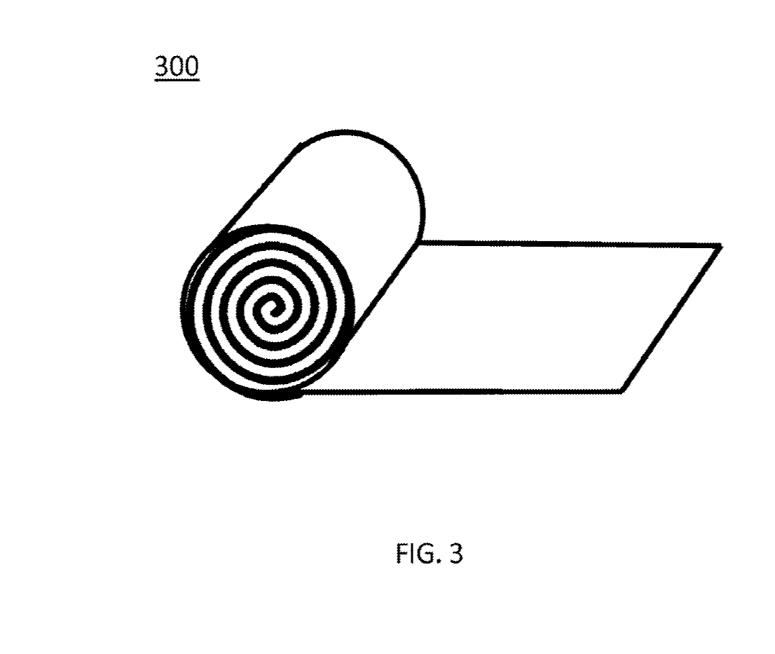

FIG. 3 is a perspective view of a roll of remote phosphor tape 300. In some embodiments, the remote phosphor tape may be flexible such that it can be rolled as shown in FIG. 3. For example, a remote phosphor tape comprising a polymeric binder and phosphor may have a polymeric binder material that is flexible. In another example, a remote phosphor tape may comprise a substrate layer with a phosphor layer disposed adjacent to the substrate layer. Both layers may be flexible and allow rolling of the remote phosphor tape. Remote phosphor tape comprising a pressure sensitive adhesive layer may further comprise a release liner.

The remote phosphor tape may be configured to be cut to obtain a smaller piece of tape with dimensions appropriate for positioning the remote phosphor tape within a particular lighting unit. The remote phosphor tape may be made with lengths of millimeters to tens of meters long, and may have widths ranging from millimeter scale to a few meters wide. The tape can be fabricated with a width and/or a length compatible with a dimension desired for application in a lighting unit. For example, for application in a fluorescent tube replacement, the remote phosphor tape may have a length of 48 inches, for example, and a width of a few millimeters, such that the tape does not need to be cut into smaller pieces, or a larger width, requiring cutting of the tape to dimensions appropriate for the application of the remote phosphor tape in the lighting unit.

### Methods of Using

The remote phosphor tape may be disposed on a support structure in a lighting unit. In an LED device, the support structure may be configured to provide support to the remote phosphor tape such that the remote phosphor tape can be spatially separated from the LED device package. The support structure may also serve as an optical component. For instance, the support structure may be a lens, reflector, or a diffractor.

In the exemplary embodiments that follow, a remote phosphor tape is disposed on a support structure in a lighting unit. The lighting unit comprises light emitting elements that are spatially separated from the remote phosphor tape. The light emitting units and the phosphor material in the remote phosphor tape phosphor layer are chosen such that the light emitting unit emits at least some light of a wavelength that can be used to excite at least some of the phosphor material in the remote phosphor tape. The phosphor material is configured to absorb this excitation wavelength and re-emit the absorbed radiation as light of a different, generally longer, emission wavelength. Thus, the phosphor is used to color-convert at least some of the light generated by the light emitting elements.

In embodiments described herein, the lighting unit comprises a light emitting element such as a light emitting diode (LED) or a laser diode which is configured to emit light of a first wavelength when illuminated. The light emitting element may be a white light emitter, a UV, or blue light emitter, for example. In addition to light of a first wavelength, the light emitting element may emit light of other wavelengths as well. For instance, the light emitting element may be a white light LED that comprises an LED that emits blue light and a yellow phosphor. The yellow light emitting phosphor is in a silicone or epoxy that surrounds the LED package. The yellow phosphor receives the blue light and down converts the light to a yellow light. The combination of blue and yellow light appear substantially white to a human observing the light output of the light emitting element package. The light from the light emitting element is directed towards the remote phosphor tape. Thus, the phosphor in the remote phosphor tape is excited by the radiation of the first wavelength and then emits light of a second, different wavelength. Usually, the phosphor will down-convert the light, meaning the excitation wavelength, or the first wavelength, will be a higher energy (shorter wavelength) than the light emitted by the phosphor or second wavelength. Up-conversion of light is possible.

The conversion of light from one wavelength to another can be used to modify the color characteristics of the lighting unit. For instance, when a cool or bluish white light emitting element is used in a lighting unit and a warmer white light is desired, the remote phosphor tape can be added to the device to down convert some of the light of the blue wavelength to a warmer color such as orange or red. Color rendering index, color temperature, and color consistency can be affected by use of a remote phosphor tape.

The light emitting elements may be cold cathode fluorescent lamps (CCFLs) or electroluminescent devices (EL devices). Cold cathode fluorescent lamps may be of the type used for backlighting liquid crystal displays and are described generally in Henry A. Miller, Cold Cathode Fluorescent Lighting, Chemical Publishing Co. (1949) and Shunsuke Kobayashi, LCD Backlights (Wiley Series in Display Technology), Wiley (Jun. 15, 2009). EL devices include high field EL devices, conventional inorganic semiconductor diode devices such as LEDs, or laser diodes, as well as OLEDs (with or without a dopant in the active layer). A dopant refers to a dopant atom (generally a metal) as well as metal complexes and metal-organic compounds as an impurity within the active layer of an EL device. Some of the organic-based EL device layers may not contain dopants. The term EL device excludes incandescent lamps, fluorescent lamps, and electric arcs. EL devices can be categorized as high field EL devices or diode devices and can further be categorized as area emitting EL devices and point source EL devices. Area emitting EL devices include high field EL devices and area emitting OLEDs. Point source devices include inorganic LEDs and edge- or side-emitting OLED or LED devices. High field EL devices and applications are generally described in Yoshimasa Ono, Electroluminescent Displays, World Scientific Publishing Company (June 1995), D. R. Vij, Handbook of Electroluminescent Materials, Taylor & Francis (February 2004), and Seizo Miyata, Organic Electroluminescent Materials and Devices, CRC (July 1997). LED devices and applications are generally described in E. Fred Schubert, Light Emitting Diodes, Cambridge University Press (Jun. 9, 2003). OLED devices and applications are generally described in More recent developments in OLED materials and applications are generally described in Kraft et al., Angew. Chem. Int. Ed., 1998, 37, 402-428, and Z., Li and H. Meng, Organic Light-Emitting Materials and Devices (Optical Science and Engineering Series), CRC Taylor & Francis (Sep. 12, 2006).

The light emitting elements can produce a colored light, a UV or near-UV light, or a visually substantially white light. The light emitting elements can emit light of a plurality of wavelengths and their emission peaks can be very broad or narrow. The light of an excitation wavelength refers to a portion of light generated by the light emitting elements that can be color converted by the phosphor material in the remote phosphor tape. It is understood that there can be a plurality of wavelengths emitted by the light emitting elements that can fit this criteria, dependent upon the absorption profile of the phosphor material. It is also understood that the phosphor layer, comprising a combination of one or more phosphor materials, may comprise more than one phosphor material that have overlapping absorption spectra.

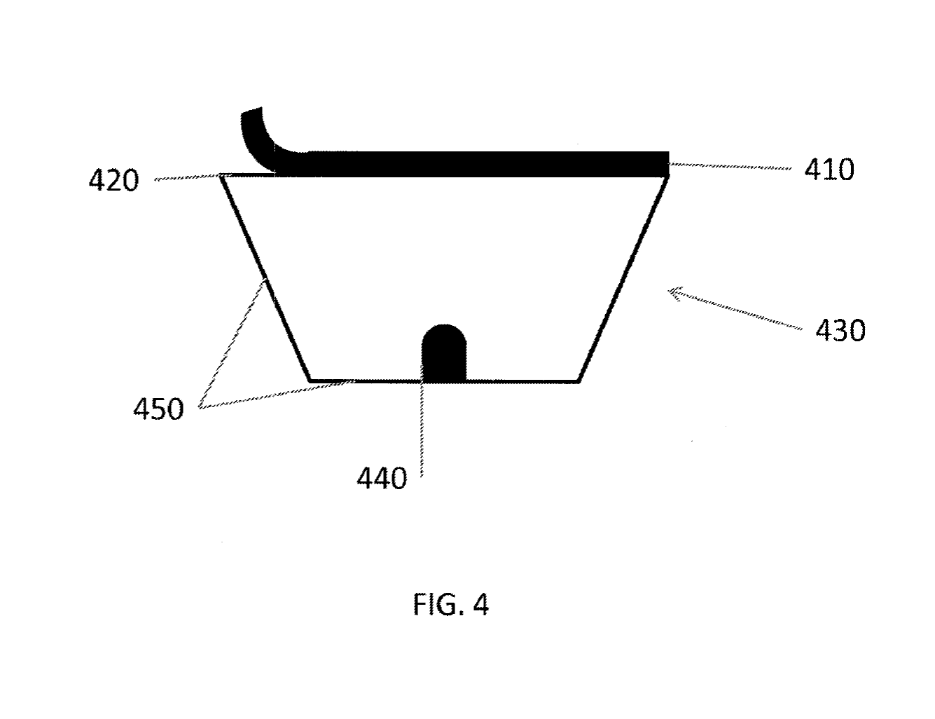

FIG. 4 is a schematic cross-sectional view of a remote phosphor tape 410 being applied to an example support structure 420 in an illustrative lighting unit 430. In this example, the lighting unit comprises light emitting element 440 such as an LED. The light emitting element 440 may be positioned in an optically reflective cavity 450 to reflect light up and out of the lighting unit 430. The remote phosphor tape 410 can be disposed on the support structure 420 with an adhesive, tacks, screws, or some other mechanical coupling device. In some embodiments, an adhesive may be applied to the phosphor tape, may be applied to the support structure, may be applied to both the phosphor tape and support structure, or is not applied to either the phosphor tape nor the support structure. Any connection mechanism may be used to affix or attach the phosphor tape to the support structure.

The support structure 420 in this illustrative lighting unit 430 is generally substantially transparent to visible and near-UV light, however in other embodiments, the support structure need not be transparent. The light emitting element 440 may be a near-UV emitter, a blue emitter, or a white LED, for example. In the case of a white LED, the LED may comprise a blue emitting LED chip coated with a yellow phosphor, for example. In this example, the lighting unit will have a hybrid package-level/remote phosphor approach. The advantage of using such an approach is that improved color can be obtained and maintained with higher efficiency and longer lifetime. Red phosphors are generally the least efficient phosphors and their lifetimes and efficiency are reduced further when subjected to high temperatures. Thus, efficiency and lifetime gains with improved color can be obtained when phosphors are operated “remotely”, or displaced from the high temperature LED package.

The support structure may be a transparent mechanical support configured to provide support to the remote phosphor tape when mechanically connected thereto. Additionally, the support structure can serve as an optical component. For example, the support structure may comprise a combination of one or more refractive, reflective, or diffractive elements configured to direct light generated by the light emitting element or the phosphor material towards another optical element or out of the lighting unit to a region of desired illumination.

The support structure need not be a continuous support, but may be a frame, or grid, for example. Alternatively, the support structure may be a continuous support. Adhesive may be applied to the tape or the support. In some instances, it may be desirable to apply adhesive to the support rather than the tape when the support structure is discontinuous or has an irregular shape. Exposed adhesive on tape may attract dirt and impair performance. In some embodiments, if portions of the tape are exposed and not covered by the support, it may be desirable to provide adhesive on the support. In contrast, if portions are the support are exposed and not covered by the tape, it may be desirable to provide adhesive on the tape.

The remote phosphor tape of an appropriate length may be cut from a roll of remote phosphor tape. A release liner may be removed from the back of the remote phosphor tape to expose the pressure sensitive adhesive layer. The tape may then be applied to the support structure as shown in FIG. 4 by pressing the tape onto the support structure. The remote phosphor tape may comprise a substantially transparent to visible light polymeric binder and a phosphor, with or without a transparent substrate layer. Alternatively, the remote phosphor tape may comprise a phosphor sputtered onto a substrate layer, for example.

The lighting unit may comprise any combination of LEDs emitting light of various colors, including white LEDs. For example, the lighting unit may comprise white and red LEDs with a remote phosphor tape comprising an orange or green phosphor, for instance. In another example, the lighting unit may comprise red, green, and blue LEDs with a color-correcting remote phosphor tape that comprises a combination of down-converting phosphor materials to achieve desired CCT and CRI, for example. In another example, the lighting unit may comprise a near-UV emitting LED and a remote phosphor tape comprising a combination of red, blue and green emitting phosphor materials, for example.

In each example, in the illustrative lighting unit shown in FIG. 4, the light emitting element is configured to be powered by an external power supply and when illuminated, emit light of at least one excitation wavelength. The light emitting element and the remote phosphor tape are positioned such that the remote phosphor tape is not in contact with the light emitting element package and such that the phosphor layer receives at least a portion of the light of at least one excitation wavelength. The phosphor material is selected such that the light of a at least one excitation wavelength excites the phosphor material and the phosphor material down-converts the absorbed light of at least one excitation wavelength to light of at least one emission wavelength which is light of a longer wavelength and lower energy. In general, the phosphor material is selected such that this phosphor conversion process happens efficiently.

The light emitting element may emit light that does not excite the phosphor layer in addition to the light of at least one excitation wavelength. For example, in a lighting unit of white LEDs, the LEDs emit light in the wavelength range of red light, but this light does not excite an orange phosphor, for example. However, the light of at least one excitation wavelength may comprise light in the blue and green wavelength ranges that is emitted by the white LED.

In the example in FIG. 4, the pressure sensitive adhesive layer of the remote phosphor tape is applied to the external surface of the support structure, such that excitation light from the light emitting element passes first through the support structure and then through the pressure sensitive adhesive layer, any substrate layer, and then the phosphor layer. In another embodiment, the phosphor tape may be disposed on the internal surface of the support structure. In this case, the excitation light from the light emitting element will pass first through any protective layer, the phosphor layer, any substrate layer, or adhesive layer, and finally the support structure. In both cases, for this illustrative device, the support structure and the remote phosphor tape should be substantially transparent to visible light such that light from the light emitting element that is not absorbed by the phosphor layer and light generated by the phosphor layer can escape from the lighting unit. In order to enhance efficiency of the lighting unit, reflective components surrounding the light emitting element can be incorporated into the device. For example, a reflective cone or side walls and a reflective mount 450 can reflect be used to re-direct high angle light from the light emitting element to the phosphor layer. Additionally, light generated by the phosphor layer that is emitted back toward the light emitting element can be re-directed such that the light passes through the phosphor layer again.

### Methods of Using Reflective Remote Phosphor Tape

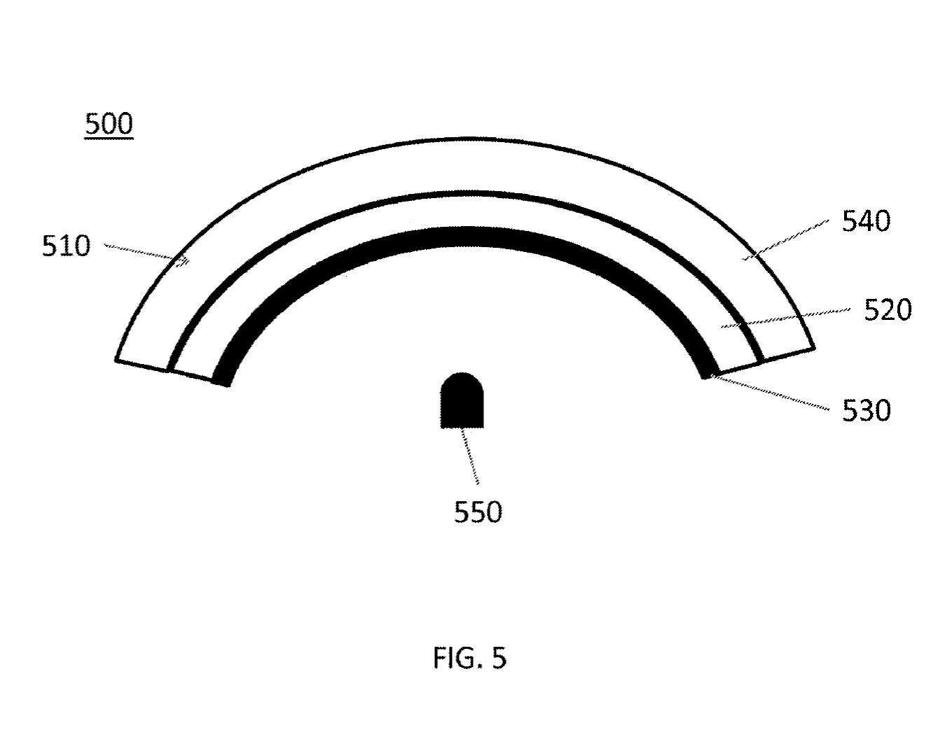

FIG. 5 is a schematic cross-sectional view of an illustrative lighting unit 500 using the remote phosphor tape 510 as a remote phosphor material. In this embodiment of the invention, the remote phosphor tape 510 is a reflective remote phosphor tape. The remote phosphor tape comprises a diffusely reflective substrate layer 520 upon which a phosphor layer 530 is disposed. The remote phosphor tape 510 is disposed on a support structure 540. The reflective substrate layer reflects light emitted by a light emitting element 550 and the phosphor layer 530, back into the phosphor layer 530 and out of the lighting unit. In this case, the support structure 540 and the reflective substrate layer 520 need not be substantially transparent, however, any protective layer disposed adjacent to the phosphor layer should be substantially transparent to visible light.

In a similar, alternative embodiment, the lighting unit comprises a support structure with a reflective surface. A remote phosphor tape with either a transparent substrate layer or without a substrate layer is disposed on the reflective surface of the support structure.

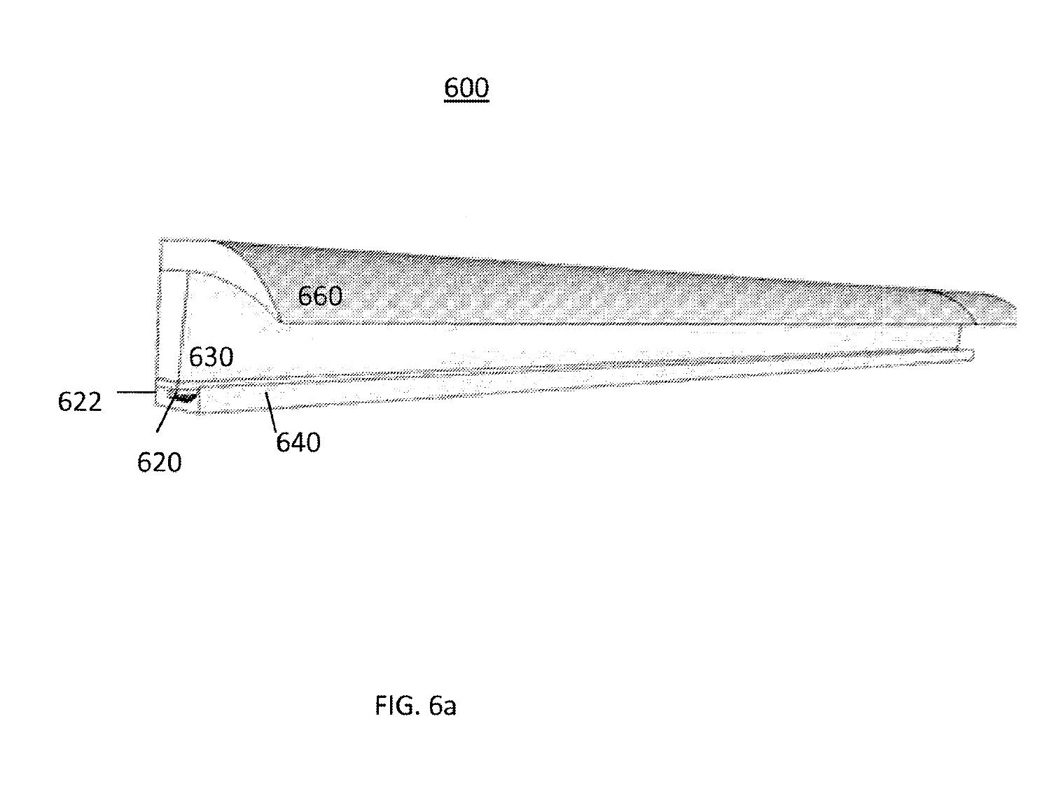

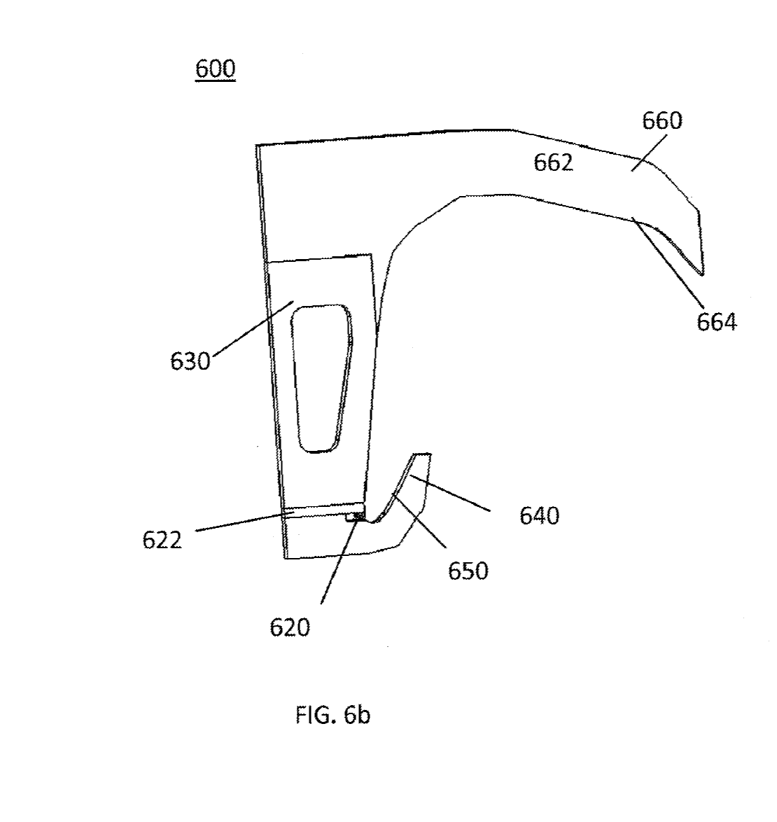

FIG. 6a is a perspective view and FIG. 6b is a schematic cross-sectional view of another example of a lighting unit 600 comprising a remote phosphor tape within a lighting unit. The lighting unit 600 depicted in FIG. 6a and FIG. 6b can be used, for example, as a fluorescent tube replacement lamp. In this embodiment, the lighting unit 600 comprises a lighting strip 610 having a plurality of light emitting elements 620. The light emitting elements 620 are disposed along the length of a heat sink 630. The light emitting elements 620 in this example can be side emitting light emitting diodes (LEDs) mounted on a circuit board 622, although in other examples, they can be mounted directly on a heat dissipating support structure. The light emitting elements may be electrically connected to one another. The light emitting elements are configured to be powered by a power supply. The power supply is generally an external power supply, though the power supply may be incorporated within the lighting unit. The power supply provides a drive condition which is a drive voltage or current appropriate to power at least some of the light emitting elements. The drive conditions can vary with time and can be programmed to change in response to feedback from a sensor or user input.

The LEDs are positioned such that light generated by the LEDs is directed towards a remote phosphor tape 650 disposed on a support structure 640. The remote phosphor tape 650 may be a reflective phosphor tape having a reflective substrate layer that directs light passing through and generated by the phosphor layer towards an optical element 660. The optical element 660 is configured to distribute the light as desired. In an alternative embodiment, the remote phosphor tape 650 may be a substantially transparent remote phosphor tape 650 disposed on a support structure 640 with a reflective component. The support structure 640 can be specular or diffusely reflective. The support structure may be at least partially reflective. It may have a continuous, substantially reflective surface, or may have regions that are reflective and regions that are not reflective or only partially reflective. In some instances, an adhesive may be provided between the phosphor tape and the support structure. In some instances, when only portions of the support structures are reflective, it may be desirable to provide adhesive only between non-reflective portions of the support structure and the phosphor tape. Alternatively, adhesive may be provided between any portions between the support structure and the phosphor tape.

The support structure may be thermally conducting, or may be disposed on a thermally conductive material, such as aluminum, so that heat generated by the phosphor material due to Stokes shift is conducted away. Thermal management at the phosphor material location can reduce thermal quenching of the quantum efficiency of the phosphor material and increase overall luminescence efficiency.

The lighting unit may have one or more optical elements 660 to distribute light in a region or regions of desired illumination. The optical elements may be light reflecting components, light refracting components, light diffracting components, or a combination thereof. The optical element may have a diffuser, a lens, a mirror, optical coatings, dichroic coatings, grating, textured surface, photonic crystal, or a microlens array, for example.

The optical element may be any reflective, refractive, or diffractive component, or any combination of reflective, refractive, or diffractive components. For instance, the optical element may be both reflective and refractive. For example, a transparent optical element may be used which reflects light off of the first optical surface and refracts light passing through the optical element. Light reflection off the first optical surface (the surface facing the base reflector) can be enhanced, for example, by deposition of a thin, semi-transparent metallic layer. Light refraction through the optical element is reflective coating on the first optical surface of the optical element. The balance of reflection and refraction can be tuned through the use of various optical coatings on the first optical surface of the optical element. Another example of a reflective and refractive optical element is a transparent optical element with mirrors spatially distributed on the first optical surface.

A reflective and refractive optical element may be advantageous for providing direct and indirect lighting. For example, with direct/indirect lighting, the lighting unit can emit light both “up” to the ceiling and “down” to the workspace. Thus, a good balance between ambient illumination of the room and accent lighting at good energy efficiency can be achieved, even in large spaces. Additionally, reflective glare on surfaces such as computer screens is reduced with indirect lighting, and three dimensional objects are rendered well without harsh shadows with indirect lighting. Another example of achieving direct/indirect lighting is to have a reflective optical element with holes or cutouts. Such an optical element can reflect a portion of the light “down” to the workspace, for example, as direct lighting from the lighting unit. Another portion of light will be transmitted “up” through the holes or cutouts in the optical reflector, to illuminate the ceiling, for example, and provide indirect lighting from the lighting unit. Directional “up” and “down” references are used herein only as examples and other configurations and orientations of the lighting unit are possible.

The shape of the optical element can define the distribution of light from the lighting unit. Additionally, the curvature or mounting angle of the optical element with respect to the position of the base reflector and light emitting elements can define the distribution of light from the lighting unit. For instance, in the lighting strip 610 in FIG. 6b, the optical element 660 can be a reflective optical element. The reflective optical element can be made of a plastic support 662 with a thin, diffusely reflective coating 664 disposed on the first optical surface which is the side of the plastic support facing the support structure 640 and the remote phosphor tape 650. The curvature of the optical element 660 can be configured to provide a broad distribution of light. Rather than a continuous reflective coating, the optical element can comprise reflective regions on the interior surface of the optical element. Furthermore, the optical element can be an extension of the heat sink support, for example. The reflective regions can be made, for example, by polishing the interior surface of an aluminum heat sink or by deposition of a thin reflective film on an aluminum heat sink surface. Additionally, the shape or configuration of the optical element can be changed to achieve a different distribution of light. For example, the radius of curvature of the optical element may be reduced in order to achieve a narrower distribution of light. Light directed towards the optical element may experience multiple reflections off of the optical element before being directed towards another optical element or exiting the lighting unit. Additionally, optical elements can be specular reflective material or diffuse reflective material. Diffuse reflective optical elements can further aid in broadening the distribution of light.

In some embodiments, the optical element is a refractive optical element such as a lens. For example, in FIG. 4, a lighting unit 400 has a support structure 420 which may also serve as a lens used to distribute light generated by the phosphor material 410 and light emitting elements 440. The lens can be shaped to provide a broad or narrow distribution of light. Refractive optical elements can be diffusers to aid in providing a more uniform light distribution. In some embodiments, there is a combination of one or more optical elements that work together to homogenize and distribute the light. For instance, in FIG. 4, reflectors 450 are angled to direct light through or from the lens 420.

Using optical elements, a very broad distribution of light can be achieved from even point source light emitting elements. Thus, a highly efficient, diffuse light source can be obtained. A major limitation of many state of the art LED lamp replacements is that LED point source emitters are used and the light is not adequately spread to provide a pleasant lighting experience. The LEDs are directly viewable or covered only by a low efficiency refractor. This provides harsh light with potential for glare and little control over the beam distribution. Furthermore, color quality and color consistency are limited by the LEDs.

### Light Distribution

To achieve superior light distribution using a reflective remote phosphor tape, the light emitting elements may be positioned such that light emitted by the light emitting elements is directed towards the phosphor material. The excited phosphor material emits light of a longer wavelength. This light is emitted in multiple directions from the phosphor material. Some of the light emitted by the phosphor material will travel in a direction away from the reflective substrate layer or support structure, and may leave the lighting unit or be reflected or refracted by an optical element. Some of the light emitted by the phosphor material will travel towards the reflective substrate layer or support structure which is positioned to reflect the light out of the lighting unit or towards an optical element. Light from the light emitting elements that is not absorbed by the phosphor material is also reflected by the reflective substrate layer or support structure and directed out of the lighting unit or towards an optical element.

The reflective substrate layer or support structure may comprise means of directing light emitted from the phosphor material. For example, the reflective substrate layer or support structure may have a photonic crystal structure, or lens shaped pockets upon which the phosphor material is disposed. Such structures may aid in directing light emitted from the phosphor material to the optical element, for example.

In some embodiments there is no optical element, so the light distribution is controlled by the position and shape of the reflective substrate layer or support structure. The reflective substrate layer or support structure can have optical features to aid in appropriately directing the light. For example, the reflective substrate layer or support structure can have reflective dimples or mounds, index-adjusting surface coatings, or other features to direct unconverted light from the light emitting elements and light from the phosphor material towards the optical element or out of the lighting unit.

### Narrow Support Structure

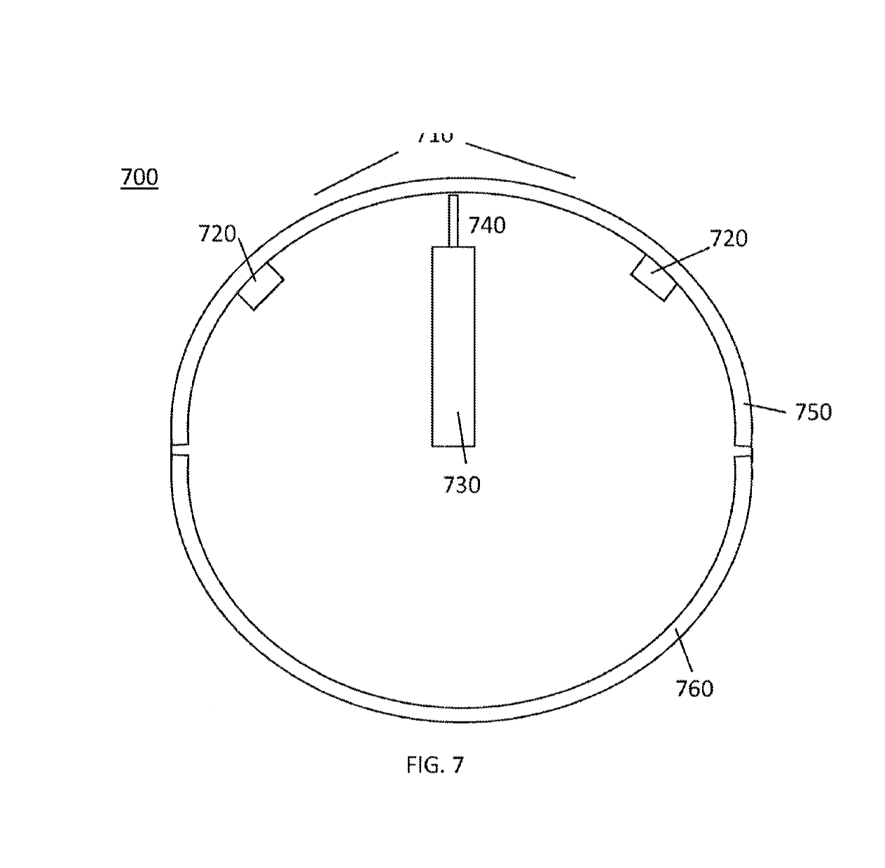

In some embodiments, a lighting unit is provided that has a remote phosphor tape mounted on a narrow support structure. FIG. 7 shows an example of such a lighting unit 700. The lighting unit may have a lighting strip comprising at least one light emitting element, a heat dissipating support structure, a phosphor material, and optionally one or more optical elements to achieve a desired distribution of light. The remote phosphor tape may be attached to a support structure such that the phosphor hangs from the support structure. In some embodiments, if a portion of the tape is hanging over the support structure, it may be desirable to provide adhesive on the support structure, rather than on the tape. In some other embodiments, if a portion of the support structures uncovered by the tape, it may be desirable to provide the adhesive on the tape rather than the support structure. Alternatively, adhesive may be applied on either surface, both surfaces, or neither surface.

FIG. 7 shows a cross-sectional view of a lighting unit 700 having two lighting strips 710 each having its own array of light emitting elements 720 and having a shared remote phosphor tape 730 that is attached to a support structure 740. The phosphor material 730 can be embedded in or disposed on an at least partially transparent plastic strip, for example. The lighting strips 710 can also share a common reflective optical element 750 and a common refractive optical element 760, for example.

### Advantages

The embodiments described herein are unique and offer significant performance and cost advantages. The remote phosphor tape allows for a highly efficient lighting unit with low cost, improved light distribution and superior color characteristics including color quality such as desired CRI and CCT, and color consistency, device-to-device and over time. The remote phosphor tape also importantly facilitates incorporation of phosphor material in a lighting unit and can be tailored to provide consistent and well controlled amount and thickness of phosphor material amongst lighting units. Methods may be employed to dispose various amounts of different phosphor material on the tape to provide for the desired color adjustment in a lighting unit.

Aspects of the invention allow for a highly efficient lighting unit. The efficiency of the lighting unit will be a function of the LED efficiency, the thermal management, the phosphor material down conversion and scattering, and the optical efficiency of the system. In a system using the remote phosphor tape to achieve a desirable warm light for general illumination from cool white LEDs, the use of a phosphor on the LED chip and a warming remote phosphor on a reflective substrate layer or support structure will reduce the thermal quenching of the red and/or orange phosphors which are the most thermally sensitive phosphors and may allow the use of even more thermally sensitive phosphors which have higher conversion efficiencies.

Cost advantages of the invention are also significant. The cost of the remote phosphor is reduced by depositing phosphor material in concentrated spots or strips on a tape and then reflecting the light for distribution. The amount of phosphor material in the phosphor tape can be well controlled, and material is not wasted by trying to dispose the phosphor directly on a lighting unit by means of solution or vapor deposition techniques. With the excitation light directed to the remote phosphor tape, the phosphor material can be concentrated in a narrow strip, saving material costs. Diffuse light can be obtained when the phosphor layer is disposed adjacent to a reflective surface, for instance. The hybrid phosphor approach of using white phosphor converted LEDs with a phosphor on or in the package in combination with a remote phosphor tape further to achieve white light of desirable color characteristics also can reduce the amount of phosphor needed and hence the cost of manufacture, while improving the efficiency of the devices. Other approaches that incorporate remote phosphor throughout the lens help to get diffuse light, but require significantly more phosphor material which can lead to prohibitive costs.

In addition to cost and efficiency advantages, aspects of the invention can provide improved light output, light distribution, color quality, and color consistency. The use of primarily reflective optics makes it much easier to tune the light distribution, particularly with the use of two reflective surfaces. For color control, homogenization of the cool white output from the LEDs can be accomplished by the controlled use of LEDs with different specific color points. The combined output of these LEDs can be tuned to meet a consistent color point. By using a remote phosphor tape, the specific amount of red and/or orange phosphor materials can also be controlled to adjust the light output. The multiple reflections can also evenly distribute the colors with respect to output angle. Because phosphor materials of the red and/or orange wavelengths are typically most sensitive to heat, locating the phosphor remotely allows for slower degradation and improved lifetime and efficiency of the red and/or orange phosphor which will allow the color set point to be maintained for longer.

### EQUIVALENTS

While the invention has been described in connection with specific methods, embodiments, and apparatus, it is to be understood that the description is by way of example and not as a limitation to the scope of the invention as set forth in the claims.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A remote phosphor tape for use in lighting units, comprising:
a front side;
a backside; and
a phosphor layer comprising a phosphor material configured to emit light of an emission wavelength when illuminated by light of an excitation wavelength,
wherein said remote phosphor tape is configured for use as a remote phosphor in a lighting unit.

2. The remote phosphor tape of claim 1, wherein the phosphor layer further comprises a polymeric binder material.

3. The remote phosphor tape of claim 1, further comprising a substrate layer.

4. The remote phosphor tape of claim 3, wherein the phosphor layer is deposited on the substrate layer through one of a chemical or physical vapor deposition technique.

5. The remote phosphor tape of claim 3, wherein the phosphor layer is disposed on the substrate layer through a printing technique.

6. The remote phosphor tape of claim 3, wherein the substrate layer is reflective.

7. The remote phosphor tape of claim 6, wherein the substrate layer is diffusely reflective.

8. The remote phosphor tape of claim 1, further comprising a pressure sensitive adhesive layer disposed adjacent to the back side of the phosphor tape.

9. The remote phosphor tape of claim 1, wherein the phosphor tape is flexible.

10. A lighting unit, comprising:
at least one light emitting element, configured to emit a light of at least one excitation wavelength when illuminated;
a support structure spatially separated from the at least one light emitting element; and
a remote phosphor tape disposed on said support structure, the remote phosphor tape comprising:
a front side;
a back side; and
a phosphor layer comprising a phosphor material configured to emit light of a emission wavelength when illuminated by the light of at least one excitation wavelength,
wherein the at least one light emitting element and the remote phosphor tape are positioned such that a portion of the light of at least one excitation wavelength emitted by the at least one light emitting element is received by the phosphor layer in the remote phosphor tape.

11. The lighting unit of claim 10, wherein the support structure is at least partially reflective.

12. The lighting unit of claim 10, wherein the remote phosphor tape further comprises a substrate layer adjacent to the phosphor layer.

13. The lighting unit of claim 12, wherein the substrate layer is substantially reflective.

14. The lighting unit of claim 13, wherein the substrate layer is diffusely reflective.

15. The lighting unit of claim 10, further comprising an optical element configured to receive and redirect light emitted and reflected by the remote phosphor tape into a region of desired illumination.

16. The lighting unit of claim 10, wherein the at least one light emitting element is a light emitting diode.

17. The lighting unit of claim 10, wherein the at least one light emitting element is a white light emitting element.
